(19) United States
(12) Patent Application Publication
(10) Pub. No.: US 2015/0063619 A1
(43) Pub. Date: Mar. 5, 2015

(54) PORTABLE SPEAKER WITH ELASTOMERIC BEZELS AND INTEGRAL ISOLATION FEET

(71) Applicant: Grain Audio, LLC, Pen Argyl, PA (US)

(72) Inventors: Mitchell Wenger, Denville, NJ (US); Christopher Weir, Mill Valley, CA (US); David Burke, Effort, PA (US); Kevin Schmudde, Darien, CT (US)

(73) Assignee: GRAIN AUDIO, LLC, Pen Argyl, PA (US)

(21) Appl. No.: 14/471,800

(22) Filed: Aug. 28, 2014

Related U.S. Application Data
(60) Provisional application No. 61/871,527, filed on Aug. 29, 2013.

(51) Int. Cl. H04R 1/02

(52) U.S. Cl. CPC H04R 1/02; H04R 2420/07
USPC 381/334

(57) ABSTRACT

A portable speaker with elastomeric bezels and integral isolation feet is provided herein. More specifically, the portable speaker comprises a speaker cabinet having a front and a rear and defining an acoustic chamber, a front speaker grill covering at least a portion of the front of the speaker cabinet, a rear speaker grill covering at least a portion of the rear of the speaker cabinet, a front elastomeric bezel positioned about a perimeter of the front speaker grill, the front bezel having a first integrated isolation foot extending from the front bezel, and a rear elastomeric bezel positioned about a perimeter of the rear speaker grill, the rear bezel having a second integrated isolation foot extending from the rear bezel.

### CROSS-REFERENCE TO RELATED APPLICATIONS

This application claims the benefit of U.S. Provisional Application Ser. No. 61/871,527 filed on Aug. 29, 2013, the entire disclosure of which is expressly incorporated herein by reference.

### BACKGROUND

1. Field of the Disclosure

The present disclosure relates generally to a portable speaker with elastomeric bezels and integral isolation feet.

2. Related Art

Mobile electronic devices (e.g., tablets, computers, smartphones, etc.) are becoming increasingly more popular, and are consistently used to electronically store and play music. As a result, there is a growing need for portable speakers for such devices.

Portable speakers can suffer from a number of disadvantages. For example, portable speakers can slide across surfaces, and as a result, potentially fall off of those surfaces and damage the speaker. Additionally, some portable speakers output sound in only one direction, thereby limiting the maximum output volume. Still further, the edges of the speakers can be damaged if they are not adequately cushioned and the speaker is dropped on an edge.

Therefore, there is a need in the art for a portable speaker that will not slide across surfaces, is cost efficient and simple to manufacture, is adequately cushioned, and can play music from a variety of different sources (e.g., remote computer, tablet computer, smartphone, etc.).

### SUMMARY

The present disclosure relates to a portable speaker system with elastomeric bezels and integral isolation feet. The bezels and isolation feet protect the speaker from impact and work as a flexible acoustic gasket which seals the interface between the molded plastic speaker baffle and a solid wood acoustic chamber of the speaker cabinet. Further, the bezels and isolation feet provide a flexible footing with sufficient grip such that the unit will not slide across a surface.

### BRIEF DESCRIPTION OF THE DRAWINGS

The foregoing features will be apparent from the following Detailed Description, taken in connection with the accompanying drawings, in which:

FIG. 1 is a front perspective view of a portable speaker with elastomeric bezels and integral isolation feet in accordance with the present disclosure;

FIG. 2 is a rear view of the portable speaker;

FIG. 3 is a rear view of the portable speaker, showing the portable speaker with one grille removed;

FIG. 4 is a top view of the portable speaker;

FIGS. 5-6 are bottom views of the portable speaker;

FIGS. 7-8 are left side views of the portable speaker; and

FIG. 9 is a diagram of circuitry of the portable speaker.

### DETAILED DESCRIPTION

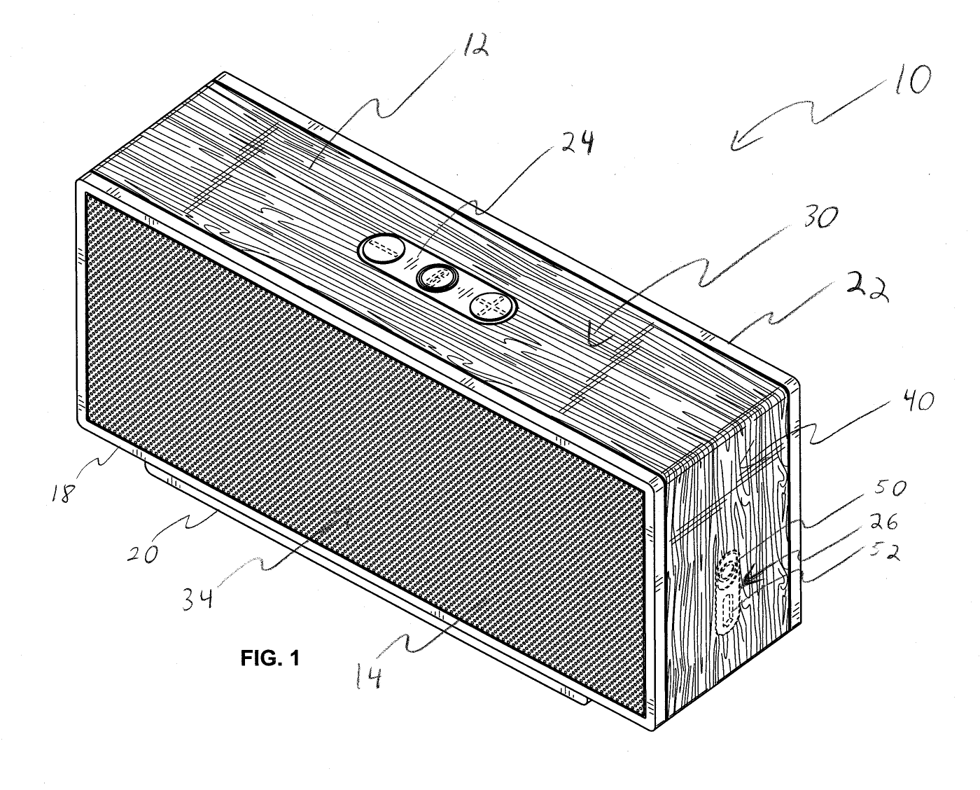

The present disclosure relates to a portable speaker with elastomeric bezels and integral isolation feet, as discussed in detail below in connection with FIGS. 1-9.

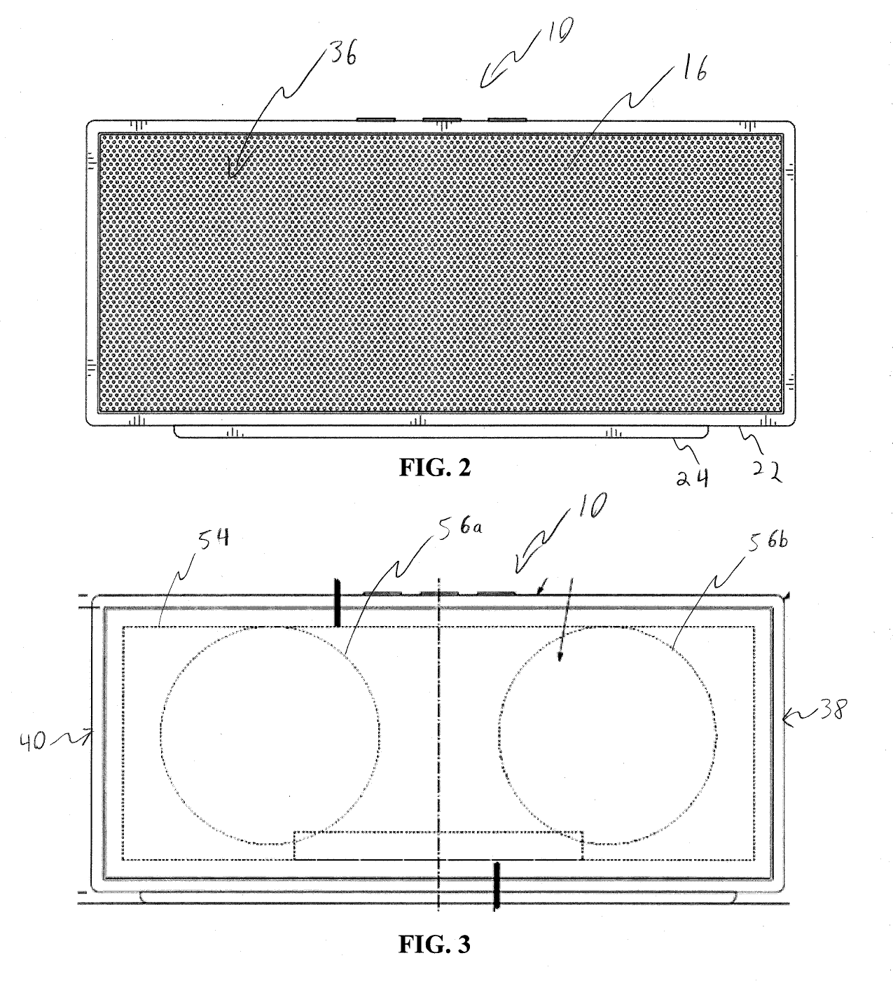

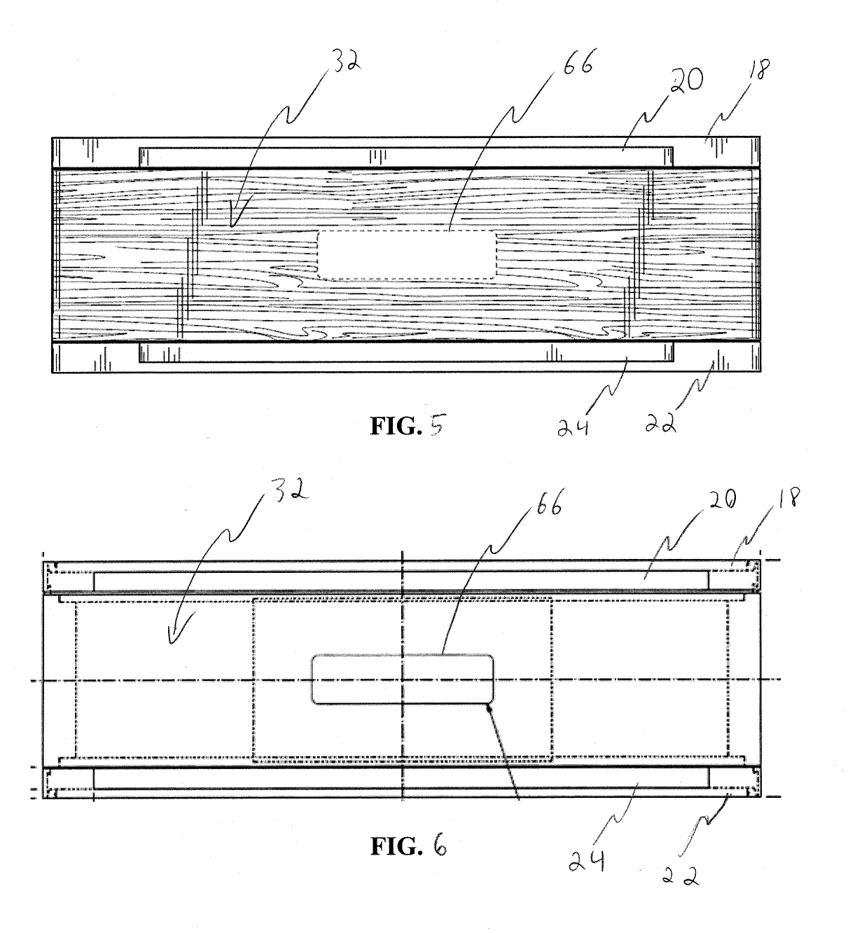

FIG. 1 is a front perspective view of a portable speaker with elastomeric bezels and integral isolation feet in accordance with the present disclosure. The speaker 10 comprises a speaker cabinet 12, a front speaker grill 14, a rear speaker grill 16 (see FIG. 2), a front bezel 18 having an integrated isolation foot 20, a rear bezel 22 with an integrated isolation foot 24 (see FIG. 2), a central panel 24, and a connection panel 26. The design of the speaker 10 and bezels 18, 22 is simple and cost-efficient to manufacture. The speaker cabinet 12 defines an internal acoustic chamber and has a top 30, bottom 32 (see FIG. 5), front 34, rear wall 36 (see FIG. 2), left wall 38 (see FIG. 3), and right wall 40. The speaker cabinet 12, and the surfaces thereof, could be of any of a variety of shapes (e.g., cubical, spherical, etc.). The speaker cabinet 12 could be made of wood (e.g., solid wood) or any of a variety of other materials (e.g., plastic). It is believed that, if the cabinet 12 is made of wood, better acoustic properties are afforded the cabinet 12.

The speaker 10 includes a connection panel 26 on the right wall 40 of the cabinet, which includes one or more electrical connectors (the connectors could be separated and could be located on any side of the cabinet, if desired). The connection panel 26 is flush against the right wall 40 and includes a silicone cover to protect the connectors. The connectors could include an auxiliary-input port 50, a universal serial bus (USB) port 52 for receiving data and/or charging a speaker battery, and/or any other type of wired input. The speaker 10 could also communicate with another device using wireless communications (e.g., Bluetooth). The speaker 10 could communicate with one or more of a variety of computer systems (e.g., remote electronic device, personal computer system, a smart cellular telephone, a tablet computer, etc.) through a network, such as a private network (e.g., Piconet, wide-area network (WAN) connection, file transfer protocol (FTP) file transfers, etc.), over the Internet (e.g., using an Ethernet connection), or any other suitable wireless (or wired) electronic communication protocol. Further, the speaker cabinet 12 houses various electronic components (e.g., a rechargeable battery, printed circuit board, and associated wiring).

FIG. 2 is a rear view of the portable speaker 10. The speaker 10 could include one or more grills, although the embodiment shown includes two (e.g., front grill and rear grill). The front speaker grill 14 (as shown in FIG. 1) and rear speaker grill 16 could be painted, perforated metal grills, although they could also be made from other materials (e.g., plastic). The front grill 14 and rear grill 16 cover substantially all of the front 34 and rear 36 of the speaker 10 (e.g., the rear grill 16 extends to the perimeter of the rear surface 36 of the cabinet). Further, the speaker grills 14, 16 could be of any shape and/or curvature to conform to the shape and/or curvature of the surfaces of the cabinet 12. As discussed in more detail below, perimeters of the front speaker grill 14 and rear speaker grill 16 are covered by bezels 18, 22.

FIG. 3 is a rear view of the portable speaker 10 showing interior elements thereof. The cabinet houses two front speakers (not shown) secured by a speaker baffle 54, with one front speaker closer to the left wall and the other front speaker closer to the right wall. The cabinet also houses two rear speakers 56 (facing a direction opposite to the front speakers) secured by the speaker baffle 54, with one back speaker 56b closer to the left wall 38 and the other back speaker 56a closer to the right wall 40. However, fewer or more speakers and/or more speaker baffles could be used.

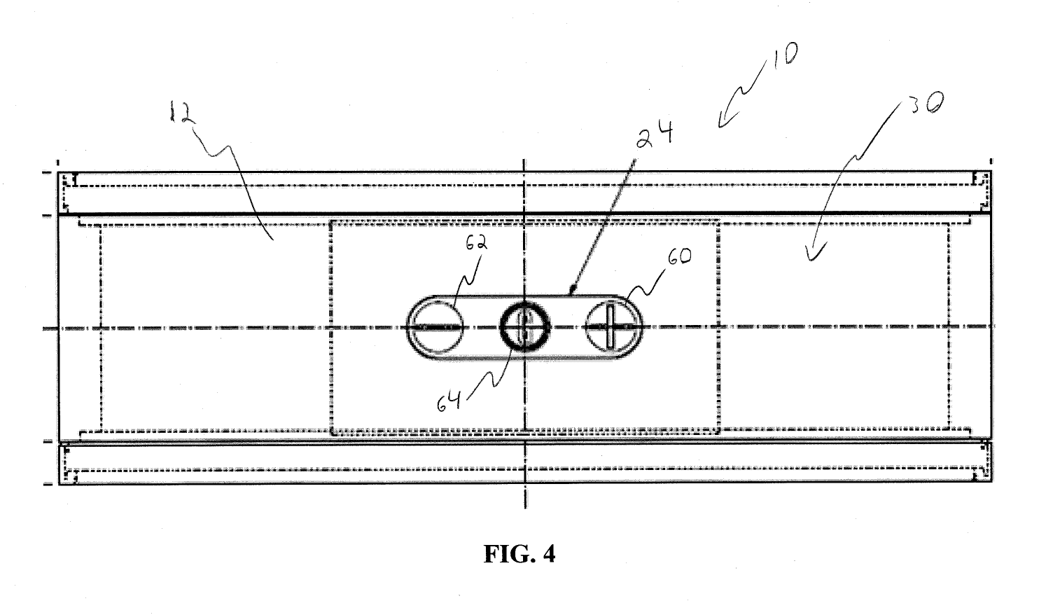

FIG. 4 is a top view of the portable speaker 10 showing exterior and interior elements thereof and a control panel. The top 30 of the cabinet 12 includes a control panel 24 for controlling the speaker volume (e.g., volume up 60, volume down 62, etc.), although the control panel could include a variety of other controls (e.g., play, stop, fast forward, etc.). However, as explained above, the speaker 10 could also be controlled wirelessly through one or more remote electronic devices. The control panel 24 could include a status light 64 (e.g., in the shape of a company logo), which could indicate whether the speaker is powered and/or receiving input (e.g., whether music is streaming to the speaker). The control panel 24 could include a touchscreen interface and/or a display (e.g., liquid crystal display (LCD), cathode ray tube (CRT), etc.). Further, the control panel 24 could include a flush set silicone button cover for protection thereof.

FIG. 5 is a bottom view of the portable speaker and FIG. 6 is a bottom view of the portable speaker showing interior elements thereof. The bottom 32 could include an ID tag 66 (e.g., FCC/CE ID tag), which could be flush set and could be colored to match the color of the elastomer bezels 18, 22 with integral isolation feet 20, 24.

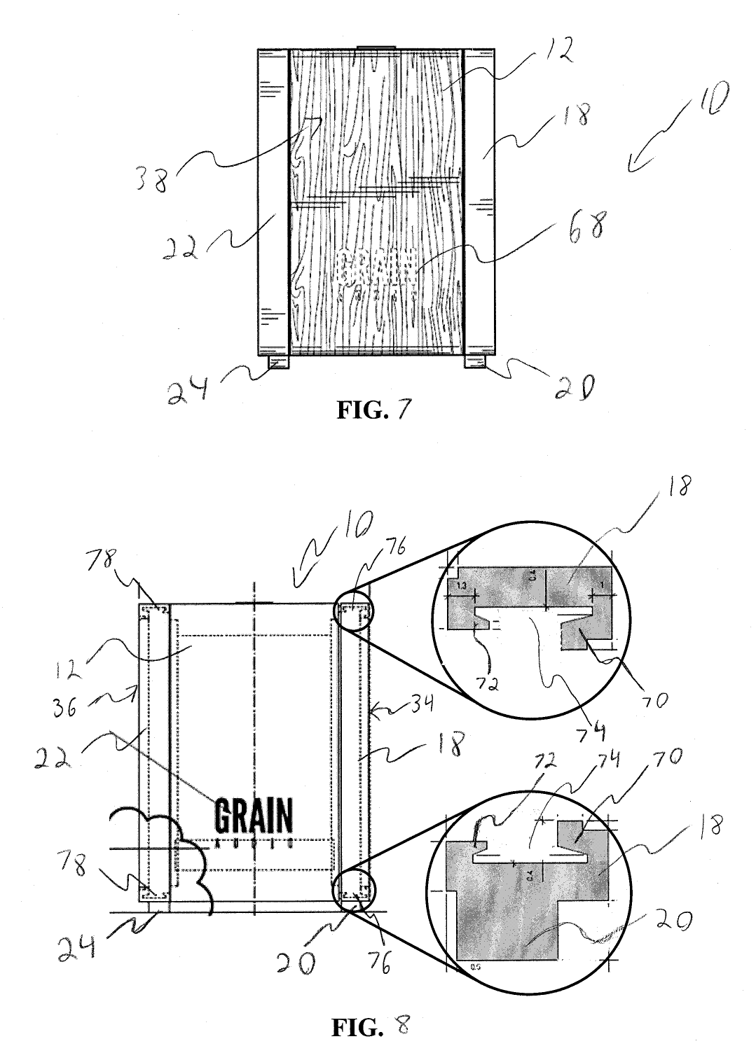

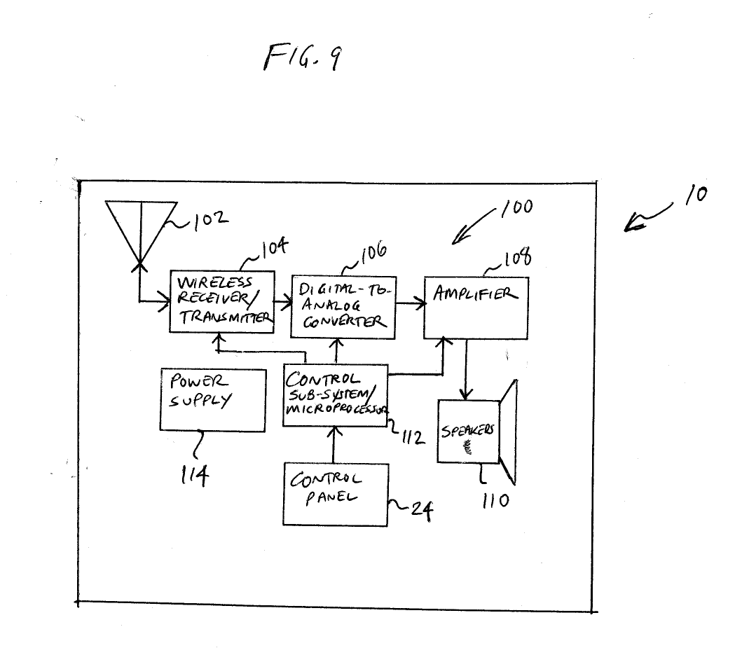

FIG. 7 is a left side view of the portable speaker. The left side (or any surface) could include a logo 68 (e.g., Grain Audio), which could be applied in any of a variety of suitable ways (e.g., laser etched). FIG. 8 is a left side view of the portable speaker 10 showing interior elements and enlarged cross-sectional views of the connection of the bezel 18. Each bezel 18, 22 and bass isolation foot 20, 24 are comprised of a contiguous molded elastomer structure (e.g., silicone). Each bezel 18, 22 and isolation foot 20, 24 protect the grill from impact (e.g., dropped or set down forcefully), and work as a flexible acoustic gasket which seals the interface between the molded plastic speaker baffle and the solid wood acoustic chamber of the speaker cabinet. Further, each bezel 18, 22 and isolation foot 20, 24 provides a flexible footing for the speaker 10 with sufficient grip such that the speaker 10 will not slide across a surface at maximum volume and/or maximum bass output.

As shown in the enlarged cross-sectional views, each bezel 18, 22 has an outer protrusion 70 that extends towards the cabinet 12 from the front of the bezel, and an inner protrusion 72 that extends away from the cabinet 12 from the back of the bezel, where the protrusions 70, 72 define a recess 74. Along the perimeter of the front and back surface of the cabinet 12, the cabinet 12 has a protrusion 76 that is correspondingly shaped to the recess 74 of the bezel 18. In this way, the front bezel 18 having an integrated isolation foot 20 is attached at the front 34 of the speaker cabinet 12 by protrusion 76, and the back bezel 22 with integral isolation foot 24 is attached at the back 36 of the speaker cabinet 12 by protrusion 78. More specifically, the front bezel 18 attaches at the perimeter of the front 34 of the cabinet 12 such that a portion of the perimeter of the front speaker grill is secured between the outer protrusion 70 of the bezel 18 and the front surface of the cabinet 12, thereby attaching the speaker grill to the cabinet 12. It is noted that bezels 18, 22 could be flush with the top, bottom, left, and right surfaces of the cabinet 12.

As shown in FIGS. 7-8 (as well as in FIGS. 2 and 5), the isolation foot 20, 24 is integral with the bezel 18, 22 and extends from a bottom surface of each bezel 18, 22. Each isolation foot 20, 24 is approximately as tall as the bezel 18, 22, but not as thick or wide (although it could be). In this way, for example, the front surface of isolation foot 20 is not flush with the front surface of the bezel 18, and the left and right surfaces of the isolation foot 20 are not flush with the left and right surfaces of the bezel 18 (although it could be). The bezel 18, 22 and isolation foot 20, 24 have been described as integral, however, it is anticipated that the bezel 18, 22 and isolation foot 20, 24 could be separate as well.

FIG. 9 is a diagram of circuitry 100 of the portable speaker 10. More specifically, the circuitry 100 includes a wireless antenna 102 for sending and receiving wireless signals. The wireless antenna 102 is in electrical communication with a wireless receiver/transmitter 104, which is in electrical communication with a digital-to-analog converter 106, which is in electrical communication with an amplifier 108, which is in electrical communication with speakers 110 to output the received signal. Control panel 24 is in electrical communication with control sub-system microprocessor 112, which is in electrical communication with the wireless receiver/transmitter 104, the digital-to-analog converter 106, and the amplifier 108. The circuitry 100 further includes a power supply 114 to supply power to all of the circuit components. It is noted that digital components are shown but purely analog components could also be provided.

Having thus described the disclosure in detail, it is to be understood that the foregoing description is not intended to limit the spirit or scope thereof. It will be understood that the embodiments of the present disclosure described herein are merely exemplary and that a person skilled in the art may make many variations and modification without departing from the spirit and scope of the disclosure. All such variations and modifications, including those discussed above, are intended to be included within the scope of the disclosure.

1. A portable speaker comprising:
a speaker cabinet having a front and a rear and defining an acoustic chamber;
a front speaker grill covering at least a portion of the front of the speaker cabinet;
a rear speaker grill covering at least a portion of the rear of the speaker cabinet;
a front elastomeric bezel positioned about a perimeter of the front speaker grill, the front bezel having a first integrated isolation foot extending from the front bezel; and
a rear elastomeric bezel positioned about a perimeter of the rear speaker grill, the rear bezel having a second integrated isolation foot extending from the rear bezel.

2. The portable speaker of claim 1, wherein the speaker cabinet is formed from wood.

3. The portable speaker of claim 1, further comprising at least one speaker positioned within the speaker cabinet.

4. The portable speaker of claim 3, further comprising an amplifier in electrical communication with the speaker.

5. The portable speaker of claim 4, further comprising a wireless receiver in electrical communication with the amplifier.

6. The portable speaker of claim 5, wherein the wireless receiver comprises a Bluetooth wireless receiver.

7. The portable speaker of claim 4, further comprising a control panel for controlling the portable speaker.

8. The portable speaker of claim 7, wherein the control panel is positioned on a top wall of the speaker cabinet.

9. The portable speaker of claim 1, wherein the first integrated isolation foot extends along a length of the front bezel.

10. The portable speaker of claim 1, wherein the second integrated isolation foot extends along a length of the rear bezel.

11. The portable speaker of claim 1, further comprising at least one port positioned in a side wall of the speaker cabinet.

12. The portable speaker of claim 1, wherein the front bezel includes a recess which receives a corresponding protrusion on the speaker cabinet for attaching the front bezel to the speaker cabinet.

13. The portable speaker of claim 12, wherein the front bezel functions as a flexible acoustic gasket which seals an interface between a speaker baffle and the acoustic chamber of the speaker cabinet.

14. The portable speaker of claim 1, wherein the rear bezel includes a recess which receives a corresponding protrusion on the speaker cabinet for attaching the front bezel to the speaker cabinet.

15. The portable speaker of claim 14, wherein the rear bezel functions as a flexible acoustic gasket which seals an interface between a speaker baffle and the acoustic chamber of the speaker cabinet.
